(19) United States
(12) Patent Application Publication
(10) Pub. No.: US 2017/0054785 A1
(43) Pub. Date: Feb. 23, 2017

(54) Communication system with Edit Control

(71) Applicants: Jesse Alexander Trafford, Deep River (CA); Raychel Stephanie Clark, Deep River (CA)

(72) Inventors: Jesse Alexander Trafford, Deep River (CA); Raychel Stephanie Clark, Deep River (CA)

(21) Appl. No.: 14/828,288

(22) Filed: Aug. 17, 2015

(51) Int. Cl. H04L 29/08

(52) U.S. Cl. CPC H04L 67/06; H04L 67/10

(57) ABSTRACT

The invention provides a primary electronic transceiver operatively associated with a secondary electronic transceiver whereby the upload and/or download of media files is subject to approval on executed from the secondary electronic transceiver.

### BACKGROUND OF THE INVENTION

In the electronic age, it is often difficult to monitor the activities of minors and the information that is shared. One particular area of difficulty relates to minors transmitting and/or uploading media files from their electronic devices. There exists a need for an efficient way to monitor and control the transmission of media files from a minor user.

### SUMMARY OF THE INVENTION

In one embodiment, the present invention is a method for controlling electronic transmission of media files, said method comprising the steps of: providing a first electronic transmission device, wherein said device is configured with a means for requiring approval prior to transmitting or receiving media files; a second device operatively associated with said first device, wherein said second device is configured to selectively provide approval or disapproval of the media transmission of said first device, sending a media file from said first device to said second device; selectively approving or disapproving said media files; transmitting said approval or disapproval to said first device; and altering the display on said first device indicting permitting or denying permission for said first device to transmit said media files.

In one embodiment each of the first electronic transmission device and second electronic transmission device is at least one of a cell phone, smartphone, tablet computer, laptop computer, desktop computer or combinations thereof. A single user can have more than one device used in the invention. For example, a parent can have their smart phone and tablet each operatively associated with the cell phone of a child. Additionally, a child can have a cell phone and tablet each requiring parental approval from a plurality of parental controlled devices.

In one embodiment, the transmission is received on the first device, but the media file is displayed only on the second device and is only transmitted to the first device if approved.

In one embodiment, the transmission is the receiving of a media file, from a pre approved list including at least one email or phone number is provided that permits receipt of a media file on the first device without approval. A non-limiting example would be allowing a grandparent pre-approved access to send media files to a grandchild.

In one embodiment, the receipt of a media file on the first device without approval includes a copy displayed on the second device.

### BRIEF DESCRIPTION OF THE SEVERAL VIEWS OF THE DRAWINGS

FIG. 1A is a flow chart demonstrating the initial steps of the method according to one embodiment of the present invention.

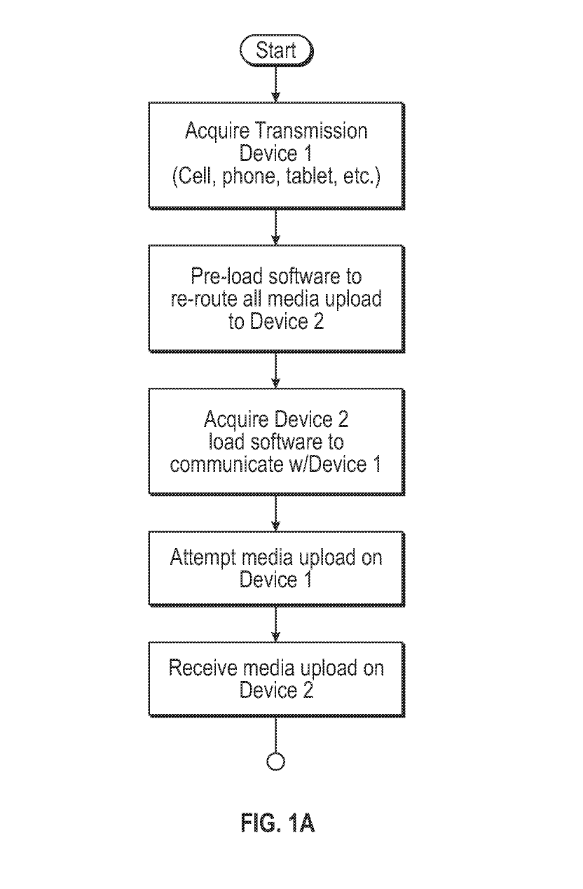

FIG. 1B is a continuation from FIG. 1A demonstrating the subsequent and concluding steps of the method according to one embodiment of the present invention.

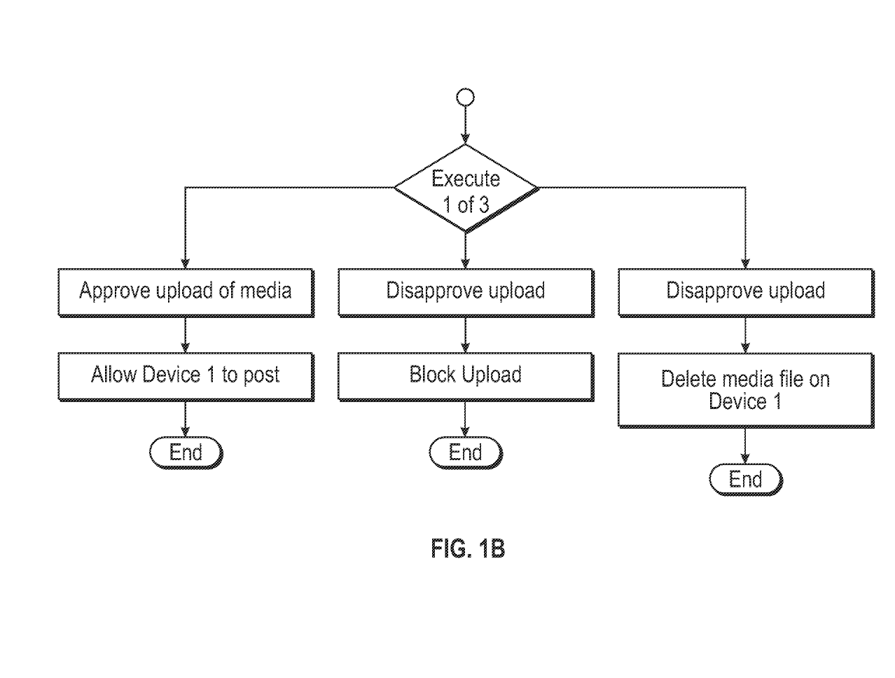

### DETAILED DESCRIPTION OF THE PREFERRED EMBODIMENTS

The present invention relates in general to editorial control of the uploading of media files from an electronic communication device. The electronic communication device includes any one of a cell phone, smart phone, tablet, or any device or combination thereof constructed and arranged to transmit media files electronically. The media files, as understood in the present invention, include any one of still photographs, compilations, video files, or combinations thereof.

A first transmission device is preloaded with software such that any attempt to electronically transfer a media file immediately actuates a second device. The second device is operatively associated with the first device and receives the media files that are the subject of the transmission. The operator of device 2 will view the media file and be given one of three operational functions. Function 1 is to approve the upload of the media file. When this function is selected, a command is sent to device 1 and device 1 then becomes operational to upload the specific media file that has been approved by the user of device 2. If the user of device 2 disapproves of a media transmission, device 2 sends an operational command to device 1 and the media transmission is blocked and not permitted. The user of device 2, in one embodiment, can disapprove of transmission and/or upload and further request the deletion of a particular media file on device 1.

By way of one example, device 1 is a device used by a minor child. In this particular example, device 1 is a smart phone used by the minor child. Device 1 has preloaded software that requires any attempted transmission or upload of a media file to be approved by a secondary device. In this example, device 2 is a cell phone in the control of a parent, guardian, or other adult figure. When the child attempts to upload or transmit media files, the adult possessing capability in device 2 has the opportunity to approve or disapprove of the transmission.

In another, non-limiting example, device 1 is configured such that all incoming media files are sent to device 2. Device 2 executes the same selection from the three options set forth above being:

Function 1 is to approve the upload of the media file and allow it to be viewed on device 1. When this function is selected, a command is sent to device 1 and device 1 then becomes operational to download the specific media file that has been approved by the user of device 2.

If the user of device 2 disapproves of a media transmission, device 2 sends an operational command to device 1 and the media transmission is blocked and not permitted.

In one embodiment of the present invention, the system is configured to always allow transmission to a particular recipient; for example, a child with device 1 attempting to share media files with a grandparent or other approved recipient. In this embodiment, device 2 provides a list of transmission recipients that are always able to receive media files without first requiring approval and permission of device 2.

While the invention has been described in its preferred form or embodiment with some degree of particularity, it is understood that this description has been given only by way of example and that numerous changes in the details of construction, fabrication and use, including the combination and arrangement of parts, may be made without departing from the spirit and scope of the invention.

What is claimed is:

1. A method for controlling electronic transmission of media files, said method comprising the steps of: providing a first electronic transmission device, wherein said device is configured with a means for requiring approval prior to transmitting or receiving media files; a second device operatively associated with said first device, wherein said second device is configured to selectively provide approval or disapproval of the media transmission of said first device, sending a media file from said first device to said second device; selectively approving or disapproving said media files; transmitting said approval or disapproval to said first device; and altering the display on said first device indicting permitting or denying permission for said first device to transmit said media files.

2. The method of claim 1 wherein said first electronic transmission device is at least one of a cell phone, smartphone, tablet computer, laptop computer, desktop computer or combinations thereof.

3. The method of claim 1 wherein said second electronic transmission device is at least one of a cell phone, smartphone, tablet computer, laptop computer, desktop computer or combinations thereof.

4. The method of claim 1, wherein when said transmission is the receiving on the first device, the media file is displayed only on the second device and is only transmitted to the first device if approved.

5. The method of claim 1 wherein when said transmission is the receiving of a media file, a pre approved list including at least one email or phone number is provided that permits receipt of a media file on the first device without approval.

6. The method of claim 5 wherein said receipt of a media file on the first device without approval includes a copy displayed on the second device.
